(19) United States
(12) Patent Application Publication
(10) Pub. No.: US 2005/0037809 A1
(43) Pub. Date: Feb. 17, 2005

(54) Method for exchanging messages in a chat group

(76) Inventor: Qi Guan, Wien (AT)

Correspondence Address: MORRISON & FOERSTER LLP, 1650 TYSONS BOULEVARD, SUITE 300, MCLEAN, VA, 22102, US

(21) Appl. No.: 10/489,424

(22) PCT Filed: Aug. 30, 2002
(86) PCT No.: PCT/DE02/03206

(30) Foreign Application Priority Data
Sep. 14, 2001 (DE) 101454902

(51) Int. Cl. H04Q 7/20

(52) U.S. Cl. 455/556.2

(57) ABSTRACT

The invention relates to a method for exchanging messages (NAR) among the users (C, D, E, F) of at least one chat group (GR1) of a telecommunication system (SYS), according to which at least one chat message (NAR) from a mobile radio device (TE1-TE4) associated with one user (C, D, E, F) of a chat group (GR1) is transmitted to a chat service center (SER) via at least one telecommunication network (NET). Said chat service center forwards the chat message (NAR) via tie at least one telecommunication network (NET) to a mobile radio device (TE1-TE4) of at least one further user (C, D, E, F) of the chat group (GR1).

### CLAIM FOR PRIORITY

This application claims priority to International Application No. PCT/DE02/03206, which was published in the German language on Mar. 27, 2003, and which claims the benefit of priority to German Application No. 10145490.2, filed on Sep. 14, 2001.

### TECHNICAL FIELD OF THE INVENTION

The invention relates to a method for exchanging messages between participants of at least one chat group of a telecommunication system, and to a telecommunication system with at least one message transmission network, which is set up for the exchange of messages between participants of a chat group.

### BACKGROUND OF THE INVENTION

A “chat” in the telecommunication field is taken to mean an online communication between at least two subscribers, in which case the participants are freely interconnected and can express their opinions on various topics. Chatting or exchange of messages in chat groups and chat rooms has become a generally used form of communication, primarily in connection with the Internet.

A chat group or a chat room is taken to mean a communications platform which—structured in accordance with topics for example—allows the exchange of messages in a similar way to how messages are exchanged in formal or informal discussion groups. I.e. a chat group essentially represents a forum for exchange of messages. The identities of the other participants in a chat group in a telecommunication system are not normally known to the participants in a chat group. There is also the possibility that a participant, where they are not actively involved in the chat group in that they are contributing to it, is only taking part in the chat group as a listener, in which case the presence of a participant only taking part in the chat group as a listener can remain hidden from the other participants. I.e. in a chat group realized by telecommunication technology there is the possibility that only the active participants, i.e. those making contributions to the chat group, appear to the other participants.

To understand the terms “chatting” or “chat rooms” see, for example, U.S. Pat. No. 6,061,761 which describes a “chat room system” in a computer network. In this connection U.S. Pat. No. 6,081,830 is also known, which describes a method for connecting with program-specific “chat rooms”.

To date there is no function known for mobile radio terminals which allow a number of subscribers to chat to each other. The realization of this type of function for mobile radio terminals is however of great practical significance where a number of users of mobile radio telephones wish to exchange information with other users (unknown to them). Thus, for example, in the traffic area it can be of great importance for users in traffic to quickly exchange information or messages with each other with regard to the traffic situation. The notification of location-based information, for example, local traffic situations by traffic users is in fact known from the area of traffic radio. This information which is generally transmitted using a mobile radio terminals to a mobile radio control center is made available to other traffic users by radio. The disadvantage of these known methods in particular is that they are very unspecific and only messages of higher priority, for example congestion, traffic accidents etc. are sent, so that a large part of the information for traffic users in the region gets lost.

### SUMMARY OF THE INVENTION

The invention discloses an informal exchange of information in the form of a chat between users of mobile radio terminals, and for local information which is directly relevant to a traffic user to be exchanged with other traffic users.

In one embodiment of the invention, there is at least one of chat message from a mobile radio terminal assigned to one of the participants in the chat group is transmitted via at least one message transmission network to a chat service center which forwards the chat message via at least one message transmission network to at least one mobile radio terminal assigned to one further participant in the chat group.

In this document a chat message is taken to mean a message exchanged within the chat group between the participants of the chat group.

In another embodiment of the invention, chatting is enabled between users of mobile telephones, with the message being transmitted via the chat service center and no changes thus being required to the hardware or software of the mobile radio telephones.

One advantageous embodiment of the invention provides for the entry of a command via a subscriber's mobile radio terminal to create a chat group and for transferring the message to the chat service center which then creates and administers a chat group.

Preferably a subscriber logs on to the chat group using his mobile radio terminal via the chat service center.

A preferred embodiment of the invention provides forwarding the chat message from the chat service center to the mobile radio terminal of the at least one further subscriber to be dependent on the current geographical position of the mobile radio terminal.

This solution allows the participants of the chat group to exchange information with each other which is relevant for them on the basis of their current geographical position. In another advantageous embodiment of the invention, when a participant logs on to the chat group, a decision can be made on the chat service center side to determine whether participation by this person in the chat group should depend on their geographical position.

In another embodiment of the invention, the at least one chat message is forwarded to further participants who are located within a specifiable area around the subscriber sending the chat message. Further advantages can be obtained by assigning a chat group to a prespeciable region, in which case a prespeciable topic can also be assigned to a chat group.

The chat service center can, in one embodiment of the invention, also on request filter out chat messages that deal with a prespeciable object and submit such messages to one participant of the chat group.

The chat message can be transferred as a voice message and/or as a text message.

An especially simple to implement embodiment of the invention provides for the at least one message transmission network to be a UMTS and/or a GSM network, in which case the chat message can be transferred as an SMS message.

A further embodiment of the invention provides for the at least one message transmission network to be the Internet, in which case the chat message can be transmitted in accordance with the Voice-over-IP protocol.

To execute the method in accordance at the invention a telecommunication system of the type mentioned at the start is particularly suitable, the system being set up to transmit at least one chat message from a mobile radio terminal of a subscriber of the chat group via at least one a message transmission network to a chat service center, in which case the chat service center is set up to forward the chat message via the at least one message transmission network to a mobile radio terminal of at least one further participant of the chat group. A preferred embodiment of the invention provides for the telecommunication system to be set up to except a command sent via the mobile radio terminal of a participant for creating a chat group and transferring it to the chat service center which is set up for creating and administering a chat group. Furthermore the chat service center can be set up so that it accepts the log in of a participant to a chat group via the mobile radio terminal assigned to this participant.

Advantageously the chat service center can be set up to make the forwarding of the chat message dependent on the current geographical position of the mobile radio terminal of the at least one further participant.

Furthermore the chat service center can be set up so that, when a participant logs on to the chat group, it can determine whether participation in the chat group should depend on the geographical position of this participant.

Advantageously the chat service center can be set up to forward the at least one chat message to further participants who are located within a prespecifiable area around the participant sending the chat message.

In addition the chat service center can be set up so that it assigns a specified region to a chat group.

In accordance with a further embodiment of the invention, the chat service center can be set up so that it assigns the chat group to a specified topic.

Furthermore the chat service center can be set up so that on request it filters out chat messages which deal with a specified object and submits them to at least one participant of the chat group.

The telecommunication system can be usefully set up to transfer the chat message as a voice message and/or a text message.

In another embodiment of the invention, the at least one message transmission network is a UMTS and/or GSM network, in which case the telecommunication system can be set up so that it transfers the chat message as an SMS message.

Further advantages can be obtained by the at least one message transmission network being the Internet, whereby the telecommunication system is created so that it transmits the chat message in accordance with the Voice-over-IP protocol.

### BRIEF DESCRIPTION OF THE DRAWINGS

The invention along with further advantages is explained in more detail below using exemplary embodiments which are shown in the drawings, in which:

FIG. 1 a telecommunication system in accordance with invention.

FIG. 2 a table stored in a memory unit of a chat service center with information for controlling the chat process.

### DETAILED DESCRIPTION OF THE INVENTION

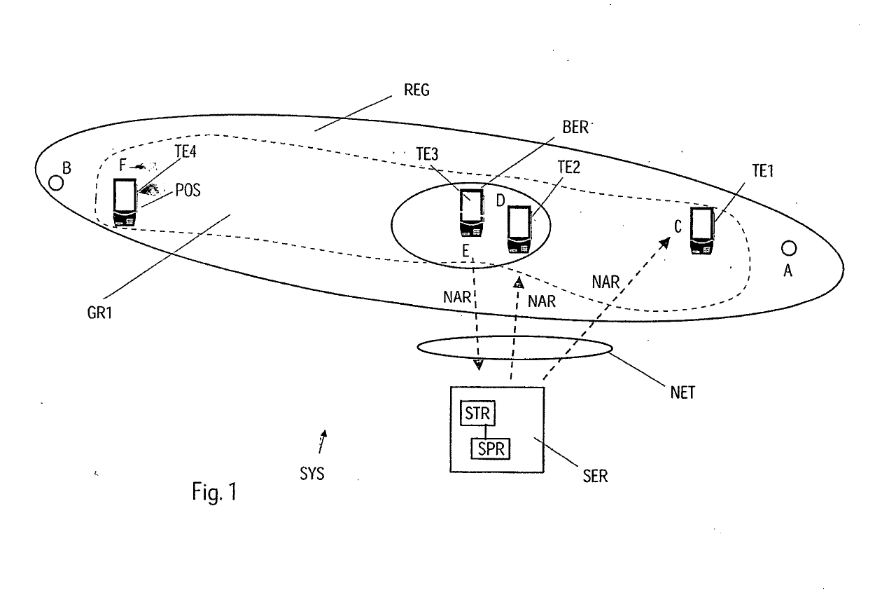

In accordance with FIG. 1, a telecommunication system in accordance with the invention SYS features at least two mobile radio terminals assigned to different subscribers TE1, TE2, TE3, TE4, which are connected via a message transmission network NET, for example a UMTS, GMS or data network—preferably the Internet—with a chat service center SER. The mobile radio terminals TE1-TE4 are for example mobile radio telephones generally known as “cellphones”.

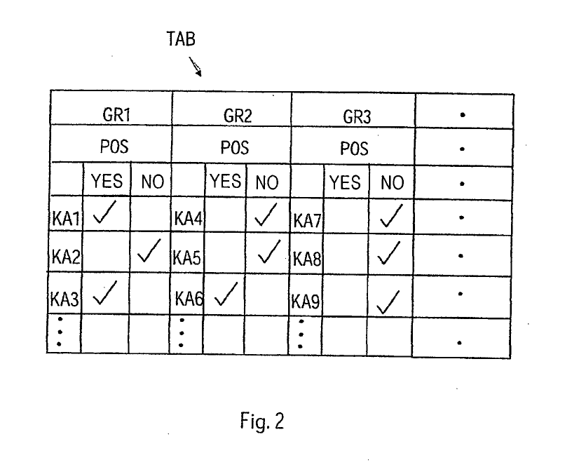

The chat service center SER can for example feature a controller STR which is set-up to except logins from participants to a chat group. Each participant who logs in to a chat group can, for example, in accordance with FIG. 2 be assigned a transmission link KA1-KA9 by controller STR for bidirectional message transmission between the chat service center and the relevant mobile terminal TE1-TE4.

These transmission links KA1-KA9 can be assigned to the various chat groups GR1, GR2, GR3, in which case the assignment of the transmission links KA1-KA9′ to the mobile terminals TE1-TE4 of participants C, D, E, F of the chat groups GR1-GR3 can the temporarily stored in a memory unit SPR, for example in the form of a table TAB. Each of the transmission links KA1-KA9 represents a communications connection between a mobile terminal TE1-TE4 and the chat service center SER, in which case the messages can be transmitted from the chat service center SER to the mobile terminals TE1-TE4, for example if a UMTS network or the Internet is used for message transmission, by means of a multimedia broadcast/multicast service.

The chat service center SER can receive from each participant C, D, E, F in a chat group GR1-GR3 via the mobile terminal assigned to this participant TE1-TE4 chat messages NAR entered in the form of text or voice messages for example. The voice messages can be entered via a voice input unit, for example a microphone of the mobile terminal TE1-TE4, and text can be entered for example using a keypad or a touchscreen of the mobile terminal. After receiving the chat message NAR the controller STR, using a the data stored in the table TAB, for example, and the transmission links KA1-KA9 assigned to the other participants of this chat group GR1-GR3, can for forward the chat message NAR to other participants C, D, E, F of the chat group GR1-GR3 via the message transmission network NET. In the event that the message transmission network NET is a GSM network the transmission links KA1-KA9 can be implemented as payload channels for example. Using their telecommunication terminals TE1-TE4 the participants can log into a chat group GR1-GR2 or a chat room of the chat service center SER and exchange information or chat messages NAR with each other in voice or text form, in which case messages between the participants C, D, E, F within the chat group GR1-GR3 can also be exchanged, as described below, to be dependent on the current geographical position POS of the participant.

Each participant has the option of either creating a new chat group GR1-GR3 or of logging into an existing chat group GR1-GR3, in which case both the creation of a new chat group GR1-GR3 and also the login to an existing chat group GR1-GR3 is advantageously undertaken via the chat service center SER.

If the message transmission network NET is a radio network, the chat service center SER can be connected via a radio interface to the transmission network NET. The chat service center SER can also, for example, be integrated into a known GSM or UMTS service center or be realized as part of a GSM or UMTS service center. The chat message can also be transferred as an SMS message in the case of a GSM or UMTS network. If the mobile terminals TE1-TE4 are linked to the Internet, chat messages in speech form can, for example, be transmitted in accordance with the Voice-over-IP protocol. To log into an existing chat group GR1-GR3 or to initialize a new chat group GR1-GR3, a participant can establish a connection to the chat service center SER via their mobile terminal TE1- TE4, for example by entering a separate directory number provided for this purpose or via a Web page on a server of the chat service center SER linked to the Internet. This web page can be retrieved and downloaded, for example, using a WAP service implemented on the mobile terminal TE1-TE4.

After successfully establishing communication with the chat service center SER or Downloading the corresponding Web page from the server of the chat service center SER, the participant can call all existing chat groups GR1-GR3, guided for example by an audible or visual menu, using their mobile terminal TE1-TE4, in order to establish whether one of these chat groups GR1-GR3 is of interest to them, i.e. whether a chat group GR1-GR3 exists which relates to the geographical region REG in which they are located or has a topic that is relevant to them as its content. For this purpose, data about existing chat groups GR1-GR2 stored in the memory unit SPR of the chat service center SER can be transferred at the request of the participant logging in C, D, E, F over the message transmission network to the mobile terminal TE1-TE4 of the participant logging in C, D, E, F. If no chat group GR1-GR3 which is of interest to the participant exists, they can initiate a new chat group GR1-GR3 in the chat service center SER. To do this they can send the corresponding command to the chat service center via a Web page using prompts from a voice menu. Furthermore the initiator of a chat group GR1-GR3 can enter the geographical region REG, for example a route between two cities A, B, using an input unit of his mobile terminal TE1-TE4, and transmit this information to the chat service center SER. The new chat group GR1-GR3 can then be assigned by the chat service center SER to this region REG or route. Since the transmission of a chat message NAR within a chat group GR1-GR3, as already mentioned above, can depend on the geographical position POS of the participant, the chat groups GR1-GR3 that can be assigned to specified regions REG are advantageously given the names that allow them to be referred back to the geographical region REG to which they relate. In this way a participant C, D, E, F, when logging into the chat service center SER, obtains a simple overview of the regions REG for which chat groups GR1-GR3 already exist.

If a participant C, D, E, F has initiated a chat group GR1-GR3 they can further chose whether they would like to receive chat messages NAR exchanged within the chat group GR1-GR3 independently of their current position, or whether they would only like to exchange messages in the chat group with participants located within a specifiable area BER around their current position POS. I.e. when a participant C, D, E, F logs in to the chat group GR1-GR3 it is possible to determine from the chat service center SER side whether there is to be position-dependent participation POS—YES, NO in the chat group GR1-GR3.

If the participant C, D, E, F decides on the last option then they can exclusively exchange chat messages NAR with participants C, D, E, F of the chat group GR1-GR3 who are located in a specifiable area BER around their current position POS. The information as to whether a participant C, D, E, F takes part in the exchange of messages in a chat group GR1-GR3 depending on their current geographical position POS or not can also be identified by an entry in the table TAB which includes control parameters for executing the chat for the controller STR. Furthermore provision can be made for the participant C, D, E, F to select the size of the area BER themselves. Another possibility consists of the choice of a number of preset areas BER of different size being offered to the participant by the chat service center SER.

The area BER “roams” with the participant C, D, E, F, with the current position POS of the subscriber C, D, E, F essentially being in the center of this area BER. For a participant C, D, E, F who has opted for the exchange of messages within a specifiable area BER this means that one “window” of region REG is visible within the chat group GR1-GR3 which moves around with him.

Naturally it is thus possible for prespecified chat groups GR1-GR3 of a service provider to exist which are assigned to specific regions REG or topics. In the case of the GSM or UMTS network, because of the cell structure of these networks, the chat service center SER has information relating to the current geographical position POS of the participants C, D, E, F in chat group GR1-GR3. On the basis of this position data the participants C, D, E, F can be classified geographically so that for example only those participants C, D, E, F of the chat group GR1-GR3 can communicate with one another who are located in the same area BER of the region REG or route.

If participants C, D, E, F are chatting via the Internet for example in accordance with the Voice-over-IP protocol, the current geographical position POS of participants C, D, E, F can be determined via GPS, with in this case however each of the participants C, D, E, F having to have a GPS device with a transmission unit for transmitting the current position data to the chat service center SER or the service center SEZ. The position data determined by the GPS unit can be transmitted to the chat service center SER for example via GSM or UMTS network. Participants C, D, E, F can for example enter a GSM or UMTS directory number assigned to the service center SER into the transmission unit of the GPS device, in which case the GPS data is submitted to the address assigned to this directory number.

Numerous forms of equipment or systems for transmitting data to a central service center have become known from the area of electronic toll equipment and are not therefore to be discussed at any greater length at this point.

Current-position-dependent participation in a chat group GR1-GR3 will be explained in greater detail using an example:

A participant C is on the way from city A to city B. Via the chat service center SER they initiate a chat group for region A to B, i.e. for the route from A to B. The chat group is given the name group A,B. Furthermore, when initializing the chat group, the initiator specifies that they would like to receive information from all other participants who log into their chat group regardless of their current geographical position within the region REG or on the route from A to B.

Some time later a participant D logs into the chat group A,B and specifies to the chat server SER that he is interested in messages from participants who for example are in an area BER of 50 km around his current position in each case. A further participant E also logs into the chat group A,B and specifies that they also only wish to exchange messages with participants in an area BER of 50 km.

A participant F logged into the chat group A,B has specified, like participant C, that he wishes to receive messages from all participants in the chat group A,B. The user F now notifies the chat group about a traffic jam in route A,B, in which he is currently stuck. Participants D and E cannot receive the message since participant F is located outside area BER. Participant E can receive the message of participant F since he has specified that he can receive the messages of all participants in the chat group A,B. If, for example, participant D reports an accident to his chat group, all other participants C, E, F of the chat group can receive his message.

After reaching their relevant destinations the participants C, D, E, F can log out of the chat group A,B, in which case logging out of the chat group A,B is undertaken advantageously by ending the connection, for example by participants C, D, E, F, going on-hook between the mobile terminal TE1-TE4 and the chat service center SER. As already mentioned above a further service feature of the present invention includes the option of participating in a chat group GR1-GR3 independently of one's current geographical position, here the participant can specify on logging in to the chat group GR1-GR3 via the chat service center SER, that he would like to participate in the chat group GR1-GR3 that he has selected independently of his current geographical position POS. Furthermore, a participant can specify to the chat service center SER that he would like to receive information on a specific topic, in which case the chat server SER on the basis of the specified topic searches the chat groups GR1-GR3 initialized on it and submits chat messages NAR relating to this topic to the mobile terminal TE1-TE4 of participants C, D, E, F. This service feature can also be used depending on or independently of the current position POS of the relevant participant C, D, E, F, in which it must be specified from the participant side C, D, E, F on logging in to a chat group GR1-GR3 or creating a new chat group GR1-GR3 to the chat service center SER whether use of this service feature is to be dependent on position POS or position-independent.

1. A method for exchanging messages between participants, of at least one chat group of a telecommunication system, comprising:
transmitting a chat message from a mobile terminal assigned to a participant of a chat group via at least one message transmission network to a chat service center; and
forwarding the chat message via the at least one message transmission network to a mobile terminal of at least one further participant of the chat group.

2. The method in accordance with claim 1, wherein a command to create the chat group is entered via the mobile radio terminal of a participant and is transferred to the chat service center which creates and administers the chat group in response thereto.

3. The method in accordance with claim 1, wherein a participant logs in using a respective mobile radio terminal via the chat service center to the chat group.

4. The method in accordance with claim 1, wherein the chat message is forwarded from the chat service center to the mobile radio terminal of the at least one further participant depending on a geographical position of the mobile radio terminal.

5. The method in accordance with claim 1, wherein, when a participant logs on to the chat group the chat service center determines whether participation in the chat group is dependent on the geographical position of the participant.

6. The method in accordance claim 1, wherein the at least one chat message is forwarded to further participants who are located within a specifiable area around the participant sending out the chat message.

7. The method in accordance with claim 6, wherein the chat group is assigned to the specifiable geographical region.

8. The method in accordance with claim 7, wherein the chat group is assigned to a specifiable topic.

9. The method in accordance with claim 1, wherein, on request, the chat service center filters out chat messages dealing with a specifiable subject and submits them to at least one participant of the chat group.

10. The method in accordance with claim 1, wherein the chat message is transferred as a voice message.

11. The method in accordance with claim 1, wherein the chat message is transferred as a text message.

12. The method in accordance with claim 1, wherein at least one message transmission network is a UMTS network.

13. The method in accordance with claim 1, wherein at least one message transmission network is a GSM network.

14. The method in accordance with claim 1, wherein the chat message is transferred as an SMS message.

15. The method in accordance with claim 1, wherein at least one message transmission network is the Internet.

16. The method in accordance with claim 15, wherein the chat message is transmitted in accordance with a Voice-over-IP protocol.

17. A telecommunication system, which is set up for exchange of messages between participants of at least one chat groups comprising:
a mobile radio terminal assigned to a chat group transmitting at least one chat message from a participant of the mobile radio terminal via at least one message transmission network to a chat service center, in which the chat service center is set up to forward the chat message via the at least one message transmission network to the mobile radio terminal of at least one further participant of the chat group.

18. The telecommunication system in accordance with claim 17, wherein the system is configured to accept a command for creation of the chat group via the mobile radio terminal of a participant and to transfer the command to the chat service center which is configured to create and administer the chat group.

19. The telecommunication system in accordance with claim 17, wherein the chat service center is configured to accept log in of the participant to the chat group via the mobile radio terminal assigned to the participant.

20. The telecommunication system in accordance with claim 17, wherein the chat service center is configured to forward the chat message depending on a geographical position of the mobile terminal of the at least one further participant.

21. The telecommunication system in accordance with claim 17, wherein the chat service center is configured so that when a participant logs in to the chat group it determines whether participation in the chat group depends on the geographical position of the participant.

22. The telecommunication system in accordance with one of the claims 17, wherein the chat service center is configured to forward the at least one chat message to a further participant located within a specifiable area around the participant sending out the chat message.

23. The telecommunication system in accordance with claim 17, wherein the chat service center is configured to assign the chat group to a specifiable region.

24. The telecommunication system in accordance with claim 17, wherein the chat service center is configured to assign the chat group to a specifiable topic.

25. The telecommunication system in accordance with claim 17, wherein the chat service center is configured so that, on request, the chat service center filters out chat messages dealing with a specifiable subject and submits them to at least one participant of the chat group.

26. The telecommunication system in accordance with claim 17, wherein the system is configured to transfer the chat message as a voice message.

27. The telecommunication system in accordance with claim 17, wherein the system is configured to transfer the chat message as a text message.

28. The telecommunication system in accordance with claim 17, wherein the at least one message transmission network is a UMTS network.

29. The telecommunication system in accordance with claim 17, wherein the at least one message transmission network is a GSM network.

30. The telecommunication system in accordance with claim 17, wherein the system is configured to transfer the chat message as an SMS message.

31. The telecommunication system in accordance with claim 17, wherein the at least one message transmission network is the Internet.

32. The telecommunication system in accordance with claim 31, wherein the system is configured to transmit the chat message in accordance with a Voice-over-IP protocol.
